(19) United States
(12) Patent Application Publication
(10) Pub. No.: US 2021/0301184 A1
(43) Pub. Date: Sep. 30, 2021

(54) ADHESIVE COMPOSITION AND ADHESIVE TAPE FABRICATED USING THE SAME

(71) Applicant: NICHIBAN CO., LTD., Tokyo (JP)

(72) Inventors: Yusuke SUGIYAMA, Tokyo (JP); Hisatoshi FUJIURA, Tokyo (JP)

(21) Appl. No.: 17/214,926

(22) Filed: Mar. 29, 2021

(30) Foreign Application Priority Data
Mar. 31, 2020 (JP) 2020-064439

(51) Int. Cl. C09J 153/02; C09J 7/10; C09J 7/38

(52) U.S. Cl. CPC C09J 153/02; C09J 7/10; C09J 7/387; C09J 2423/00; C09J 2425/00; C09J 2491/00; C09J 2453/00

(57) ABSTRACT

Provided is an adhesive tape that has higher self-adhesion force and higher self-adhesive creep resistance and does not have an odor problem of the adhesive face while maintaining HM workability. A hot-melt adhesive composition of the present invention contains at least an elastomer, a tackifier resin, a filler, and a petroleum-based plasticizer, in which the elastomer is a specific styrene-isoprene-styrene block copolymer and a terpene resin, a C5/C9 petroleum resin, and a homopolymer of a styrene-based monomer and/or a copolymer of a styrene-based monomer/an aliphatic monomer are contained as the tackifier resin.

### BACKGROUND

### Technical Field

The present invention relates to an adhesive composition suitable as a material for a self-adhesion adhesive tape and an adhesive tape fabricated using the same.

### Related Art

Self-adhesion adhesive tapes are, for example, adhesive tapes for binding various articles such as fresh vegetables, fresh flowers, documents, newspapers, and magazines. This kind of tape has the properties that the adhesive force to the article to be bound (object to be bound) is small and the adhesive force between the adhesive faces (hereinafter, referred to as “self-adhesion force”) is large. Incidentally, adhesive tapes coated with general hot-melt adhesives have high adhesive force but has insufficient self-adhesion binding property (self-adhesion force and self-adhesive creep resistance). Hence, an adhesive tape that exhibits self-adhesion binding property and can be manufactured by a hot melt method has been proposed (JP 6545466 B1).

### CITATION LIST

### Patent Literature

### [Patent Literature 1] JP 6545466 B1

### SUMMARY

### Technical Problem

An object of the present invention is to further enhance the performance of the adhesive tape according to JP 6545466 B1. Specifically, an object of the present invention is to provide an adhesive tape that has higher self-adhesion force and higher self-adhesive creep resistance and does not have an odor problem of the adhesive face while maintaining HM workability.

### Solution to Problem

The suitable present invention is a hot-melt adhesive composition containing at least an elastomer, a tackifier resin, a filler, a petroleum-based plasticizer, and an antioxidant, in which

the elastomer is a styrene-isoprene-styrene block copolymer (SIS) having a styrene content of 16% by mass or more and 40% by mass or less, and

a terpene resin, a C5/C9 petroleum resin, and a homopolymer of a styrene-based monomer and/or a copolymer of a styrene-based monomer/an aliphatic monomer are contained as the tackifier resin.

Here, an amount of the homopolymer of a styrene-based monomer and/or the copolymer of a styrene-based monomer/an aliphatic monomer blended may be 2.5% by mass or more and 55% by mass or less based on a total mass of all the tackifier resins.

An amount of the petroleum-based plasticizer blended may be 2.5% by mass or more and 9.0% by mass or less based on a total mass of the hot-melt adhesive composition.

A blended amount ratio of the homopolymer of a styrene-based monomer and/or the copolymer of a styrene-based monomer/an aliphatic monomer to the petroleum-based plasticizer (the amount of the homopolymer of a styrene-based monomer and/or the copolymer of a styrene-based monomer/an aliphatic monomer blended:the amount of the petroleum-based plasticizer blended) may be 1:0.20 to 1.20.

The homopolymer of a styrene-based monomer and/or the copolymer of a styrene-based monomer/an aliphatic monomer may be a styrene-based monomer/aliphatic monomer copolymer.

The petroleum-based plasticizer may be a naphthenic process oil.

The present invention is an adhesive tape including an adhesive layer obtained from the hot-melt adhesive composition.

Here, the adhesive tape may be for binding a vegetable.

### Advantageous Effects of Invention

According to the present invention, it is possible to provide an adhesive tape that has higher self-adhesion force and higher self-adhesive creep resistance and does not have an odor problem of the adhesive face while maintaining HM workability. In particular, the adhesive tape is useful as a vegetable binding tape that is required to have higher self-adhesion force and self-adhesive creep resistance.

### BRIEF DESCRIPTION OF DRAWINGS

FIG. 1 is a schematic diagram of a testing method in a self-adhesive creep resistance test.

### DETAILED DESCRIPTION

Hereinafter, the adhesive composition and adhesive tape according to the present invention will be described. The description of the adhesive composition will be described in detail in the description section of the adhesive tape. Hence, the overall configuration of the adhesive tape according to the present invention, the method for manufacturing the adhesive tape, the physical properties of the adhesive tape, and the use of the adhesive tape will be described in order.

### Overall Configuration of Adhesive Tape

In the adhesive tape according to the present invention, an adhesive layer is formed on/over a base material. Hereinafter, each of these members will be described in detail.

### Adhesive Layer

The adhesive constituting the suitable adhesive layer of the present invention contains at least an elastomer, a tackifier resin, a filler, a petroleum-based plasticizer, and an antioxidant. Hereinafter, the respective components and blending thereof will be described.

### Component

### Elastomer

The elastomer according to the present invention is a styrene-isoprene-styrene block copolymer (SIS) having a styrene content of 16% by mass or more and 40% by mass or less. The styrene content is suitably 20% by mass or more and 25% by mass or less. Here, the styrene content was calculated by measuring a ¹H-NMR spectrum (JNM GX400 manufactured by JEOL Ltd.) at 400 MHz using 1,1,2,2-tetrachloroethane-D2 as a solvent. The SIS may be a mixture of two or more kinds, and it is only required that the styrene content as a whole is 16% by mass or more and 40% by mass or less. For example, in the case of a SIS in which a low styrene content SIS having a styrene content of 20% by mass or less and a high styrene content SIS having a styrene content of more than 20% by mass are mixed, it is only required that the styrene content in the mixed SIS is 16% by mass or more and 40% by mass or less. When the styrene content is in this range, high self-adhesion force and high binding property to vegetables can be realized.

### Tackifier Resin

As the tackifier resin, at least a terpene resin, a C5/C9 petroleum resin, and a homopolymer of a styrene-based monomer and/or a copolymer of a styrene-based monomer/an aliphatic monomer are contained. Hereinafter, the respective resins will be described in detail.

Specific examples of the terpene resin include YS RESIN PX1250 (softening point: 120° C. to 130° C.), YS RESIN PX1150 (softening point: 110° C. to 120° C.), YS RESIN PX1000 (softening point: 95° C. to 105° C.), YS RESIN PX800 (softening point: 75° C. to 85° C.), YS RESIN PX1150N (softening point: 110° C. to 120° C.), and YS RESIN PX300N (softening point: 25° C. to 35° C.) manufactured by YASUHARA CHEMICAL CO., LTD. and Sylvares TRA25 (softening point: 25° C.), Sylvares TRB115 (softening point: 116° C.), Sylvares TR1115T (softening point: 116° C.), Sylvares TR7115 (softening point: 115° C.), Sylvares TRM1115 (softening point: 115° C.), Sylvares TR7125 (softening point: 125° C.), Sylvares TRB125 (softening point: 125° C.), Sylvares TR1135 (softening point: 135° C.), Sylvares TR90 (softening point: 90° C.), and Sylvares TRIOS (softening point: 105° C.) manufactured by KRATON CORPORATION (sold by ARBROWN CO., LTD.), and the like.

Examples of the C5/C9 petroleum resin include QUINTONE N180 (softening point: 80° C.), QUINTONE U185 (softening point: 86° C.), QUINTONE U190 (softening point: 90° C.), QUINTONE 5195 (softening point: 94° C.), QUINTONE DX395 (softening point: 94° C.), QUINTONE DX390N (softening point: 93° C.), QUINTONE D100 (softening point: 99° C.), QUINTONE E200SN (softening point: 102° C.), QUINTONE D200 (softening point: 102° C.), QUINTONE D295 (softening point: 94° C.), QUINTONE G100B (softening point: 100° C.), and QUINTONE G115 (softening point: 115° C.) manufactured by ZEON CORPORATION, and the like.

As the homopolymer of a styrene-based monomer, a general-purpose homopolymer can be used, and examples of commercially available products thereof include Piccolastic A5 (trade name, styrene homopolymer, softening point: 25° C.),

Regalrez 1018 (trade name, hydride of styrene homopolymer, softening point: 20° C.), and Piccolastic A75 (trade name, styrene homopolymer, softening point: 73° C.) manufactured by Eastman Chemical Company, YS RESIN SX100 (trade name, styrene homopolymer, softening point: 100° C.) manufactured by YASUHARA CHEMICAL CO., LTD., and FTR8100 (trade name, styrene-based monomer homopolymer, softening point: 100° C.) and FTR8120 (trade name, styrene-based monomer homopolymer, softening point: 120° C.) manufactured by MITSUI CHEMICALS, INC. Here, the softening point of the homopolymer of a styrene-based monomer is suitably 10° C. or higher and 150° C. or lower, more preferably 20° C. or higher and 130° C. or lower.

Examples of the copolymer of a styrene-based monomer/an aliphatic monomer include a styrene monomer/aliphatic monomer copolymer, an a-methylstyrene/an aliphatic monomer copolymer, and a styrene-based monomer/a-methylstyrene/an aliphatic monomer copolymer. Examples of commercially available products thereof include FTR6080 (softening point: 80° C.), FTR6100 (softening point: 95° C.), FTR6110 (softening point: 110° C.), FTR6125 (softening point: 125° C.), FTR7100 (softening point: 100° C.), and FTR7125 (softening point: 125° C.) manufactured by MITSUI CHEMICALS, INC., and the like. Here, the softening point of the copolymer of a styrene-based monomer/an aliphatic monomer is preferably 50° C. or higher and 150° C. or lower, more preferably 70° C. or higher and 130° C. or lower.

### Filler

The filler is not particularly limited, but calcium carbonate is suitable. Here, suitable calcium carbonate has a specific surface area of 0.8 m²/g or more and 2.7 m²/g or less, more preferably 1.5 m²/g or more and 2.0 m²/g or less. When the specific surface area is in this range, it is possible to effectively prevent the generation of streaks when the adhesive is applied and damage to vegetables. Here, the specific surface area means a specific surface area determined by a BET method. Here, the BET method is a method in which molecules or ions having known sizes are adsorbed on the surface of a sample and the specific surface area of the sample is measured from the amount of molecules or ions adsorbed. At this time, nitrogen gas is used as the gas to be adsorbed on the sample.

### Petroleum-Based Plasticizer

The petroleum-based plasticizer according to the present invention is, for example, a naphthenic process oil and an aromatic process oil. A naphthenic process oil is suitable particularly from the viewpoint of exhibiting excellent compatibility with other components to facilitate designing, providing well-balanced adhesive properties, and being able to decrease the viscosity at high temperatures.

### Other Additives

The adhesive according to the present invention may contain various additives (for example, antioxidant) if necessary. However, the residual solvent in the adhesive is suitably less than 10 ppm in a case in which a solvent exists. This amount can be analyzed by gas chromatography. A hot melt means one that can be applied by heating and melting the adhesive. Hence, the coating can be performed at a significantly low solvent content of less than 10 ppm.

### Blending

### Amount of Elastomer Blended

The amount of elastomer blended is preferably 30% by mass or more and 45% by mass or less based on the total mass of the adhesive composition. Here, a high styrene content SIS and a low styrene content SIS can be used singly, but a mixture thereof is suitable. In this case, the amount of low styrene content SIS blended is preferably set to 10% by mass or more and 90% by mass or less and the amount of high styrene content SIS blended is preferably set to 90% by mass or less and 10% by mass or more based on the mass of all SISs, and the amount of low styrene content SIS blended is more preferably set to 30% by mass or more and 70% by mass or less and the amount of high styrene content SIS blended is more preferably set to 70% by mass or less and 30% by mass or more based on the mass of all SISs. The styrene content in the low styrene content SIS is suitably 14% by mass or more and 20% by mass or less. Meanwhile, the styrene content in the high styrene content SIS is more suitably more than 20% by mass and 50% by mass or less, more preferably 25% by mass or more and 50% by mass or less.

### Amount of Tackifier Resin Blended

First, the amount of the tackifier resin (sum of terpene resin, C5/C9 petroleum resin, and styrene-based resin) blended is suitably 20% by mass or more and 60% by mass or less, more suitably 25% by mass or more and 55% by mass or less based on the total mass of the adhesive composition. Hereinafter, the suitable amounts of the respective components blended will be described.

First, the amount of terpene resin blended is suitably 1% by mass or more and 20% by mass or less, more suitably 5% by mass or more and 15% by mass or less based on the total mass of all the tackifier resins.

Next, the amount of C5/C9 petroleum resin blended is suitably 40% by mass or more and 85% by mass or less, more suitably 45% by mass or more and 80% by mass or less based on the total mass of all the tackifier resins.

Next, the amount of the homopolymer of a styrene-based monomer and/or the copolymer of a styrene-based monomer/an aliphatic monomer blended is suitably 2.5% by mass or more and 55% by mass or less, more suitably 15% by mass or more and 50% by mass or less based on the total mass of all the tackifier resins.

### Amount of Filler Blended

The amount of filler blended is suitably 3.5% by mass or more and 20% by mass or less, more suitably 7.5% by mass or more and 17.5% by mass or less based on the total mass of the adhesive composition. When the amount of filler blended is in this range, prevention of damage to vegetables and high self-adhesive creep resistance can be realized.

### Amount of Petroleum-Based Plasticizer Blended

The amount of petroleum-based plasticizer blended is suitably 2.5% by mass or more and 9.0% by mass or less, more suitably 3% by mass or more and 7.5% by mass or less based on the total mass of the adhesive composition.

### Blending Ratio

The blended amount ratio of the homopolymer of a styrene-based monomer and/or the copolymer of a styrene-based monomer/an aliphatic monomer to the petroleum-based plasticizer (the amount of the homopolymer of a styrene-based monomer and/or the copolymer of a styrene-based monomer/an aliphatic monomer blended:the amount of the petroleum-based plasticizer blended) is suitably 1:0.20 to 1.20.

### Base Material

The base material of the adhesive tape according to the present invention is not particularly limited, and examples thereof include porous materials formed of fibrous substances such as kraft paper, crepe paper, and Japanese paper and plastic films formed of a polyolefin-based resin, a polyester-based resin, a vinyl chloride-based resin, a polyimide-based resin, and the like.

Here, in the case of using the porous materials, those that have been appropriately treated with an impregnating agent, a back surface treatment agent, and the like may be used in order to adjust the properties such as strength, weather resistance, and rigidity. The basis weight and thickness of this porous material are appropriately selected depending on the intended use and are not particularly limited.

As the plastic films, in addition to the above-mentioned ones, biodegradable and photodegradable plastic films can be used since these are environmentally preferred ones. A plurality of those mentioned above can be used in combination, and the plastic films can be used by being layered together or the plastic films can be used by being layered with the porous materials and the like. A porous plastic film can also be used if necessary. In addition, one side or both sides of the plastic film may be subjected to surface treatment such as corona treatment, plasma treatment, or primer treatment in order to improve the close contact property of the plastic film with the adhesive that forms the adhesive layer. The base material fabricated using this plastic film can be used and the basis weight thereof is not particularly limited.

### Method for Manufacturing Adhesive Tape

The hot-melt adhesive containing the (A) elastomer component, (B) tackifier resin component, (C) filler component, and (D) petroleum-based plasticizer component described above can be obtained by kneading a raw material containing the respective components by a usual method. The hot-melt adhesive can be obtained by usually melt-kneading the raw material in a temperature range of 80° C. to 200° C. and a nitrogen gas atmosphere if necessary, for example, using a general tank mixer, closed kneader, extruder, or the like.

An adhesive tape can be obtained by applying the adhesive thus obtained onto the base material described above. Examples of the coating method include a method in which a hot-melt adhesive that is heated and melted is applied onto a base material using an applicator, a coater, or the like, a cast molding method in which a hot-melt adhesive that is dissolved in a solvent is applied onto a base material, a method in which an adherend is immersed in a molten hot-melt adhesive, a method in which a molten hot-melt adhesive is sprayed onto a base material, a laminating and molding method in which a hot-melt adhesive is laminated on a base material while being molded into a tape, and a multilayer molding method in which a hot-melt adhesive and a base material composition are simultaneously molded into films to form a laminate.

At this time, the thickness of adhesive layer is suitably 10 μm or more and 40 μm or less.

### Physical Properties of Adhesive Tape

### Self-Adhesion Force

The self-adhesion force of the adhesive tape according to the present invention is suitably 12 N/20 mm or more. The self-adhesion force testing method is as follows.

### Self-Adhesion Force Test

The tape (width: 20 mm) was used as a test piece, the test pieces were stacked so that the adhesive face of the test piece was on the inside and the bonding length was 100 mm or more under the conditions of 23° C. and 50% RH, and the stacked body was crimped one time back and forth at a speed of 300 mm/min using a 2 kg roller having a width of 50 mm and left for 20 to 40 minutes. Thereafter, the test piece was fixed to an Instron type tensile tester and peeled off in a T-type at a peeling speed of 300 mm/min, and the peeling force (N/20 mm) obtained at that time was measured.

### Self-Adhesive Creep Resistance

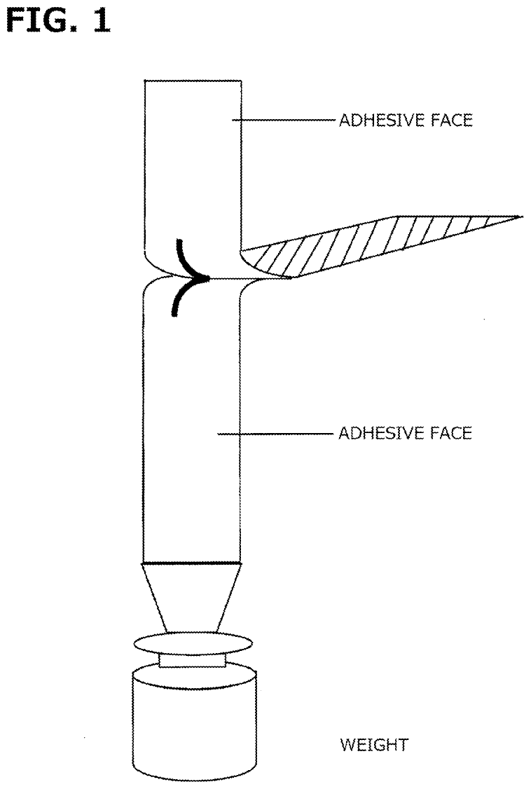

The self-adhesive creep resistance of the adhesive tape according to the present invention at 500 g and 1 hour later is suitably less than 30 mm, particularly suitably less than 20 mm. The self-adhesion force testing method is as follows (see FIG. 1).

### Self-Adhesive Creep Resistance Test

The tape (width: 20 mm) is used as a test piece, the test pieces are stacked so that the adhesive face of the test piece is on the inside and the bonding length is 100 mm or more under the conditions of 23° C. and 50% RH, and the stacked body is crimped one time back and forth at a speed of 300 mm/min using a 2 kg roller having a width of 50 mm and left for 20 to 40 minutes. Thereafter, one end of the test piece is fixed and a weight of 500 g is hung on the other end as illustrated in FIG. 1. Before the weight is hung, the bonded portion is peeled off by about 5 mm and the boundary portion is marked with oil-based ink. After 1 hour, the deviation distance (between the marks made with oil-based ink) is read using a caliper in the state in which the weight is hung.

### Intended Use of Adhesive Tape

The intended use of the adhesive tape according to the present invention is not particularly limited, but the adhesive tape is useful as an adhesive tape for self-adhesion binding. In particular, the adhesive tape is useful as an adhesive tape for self-adhesion binding to be used for binding vegetables.

### EXAMPLES

Hereinafter, the present invention will be specifically described with reference to Examples, but the present invention is not limited to these Examples.

### Raw Material

### Elastomer

### Low Styrene Content SIS

(A1) QUINTAC 3433N, ZEON CORPORATION, styrene content: 16% by mass

### High Styrene Content SIS

(A2) QUINTAC 3190, ZEON CORPORATION, styrene content: 30% by mass

### Tackifier Resin

### Terpene Resin

(B1) YS RESIN PX1150N, softening point: 115° C., YASUHARA CHEMICAL CO., LTD.

### C5/C9 Petroleum Resin

(B2) QUINTONE S195, softening point: 94° C., ZEON CORPORATION

### Aromatic Resin

(B3) Petcoal 130 (copolymer of styrene/vinyltoluene/indene, softening point: 125° C.) manufactured by Tosoh Corporation

### Styrene Homopolymer

(B4) YS RESIN SX100 (styrene homopolymer, weight average molecular weight: 2500, softening point: 100° C.) manufactured by YASUHARA CHEMICAL CO., LTD.

### Styrene-Based Monomer/Aliphatic Monomer Copolymer

(B5) FTR6125 (softening point: 125° C.) manufactured by MITSUI CHEMICALS, INC.

### Filler

(C1) SUPER #1500 (calcium carbonate, average particle size: 1.5 μm) SHIRAISHI CALCIUM KAISHA, LTD.

(C2) NIPGEL BY600 (silica, average particle size: 5 μm) manufactured by Nippon Silica Industrial Co., Ltd.

(C3) NIPGEL BY001 (silica, average particle size: 14 μm) manufactured by Nippon Silica Industrial Co., Ltd.

### Petroleum-Based Plasticizer

(D1) SNH100, naphthenic process oil, pour point: -27.5° C., manufactured by SANKYO YUKA KOGYO K.K.

### Others

(E1) Antioxidant: ANTAGE AW-500 manufactured by Kawaguchi Chemical Industry Co., Ltd.

### Manufacturing Method

### Example 1

With 40 parts by mass of (A1) and 60 parts by mass of (A2) as elastomers, 20 parts by mass of (C1), 10 parts by mass of (C2), and 2 parts by mass of (C3) as fillers, 10 parts by mass of (B1), 60 parts by mass of (B2), and 30 parts by mass of (B4) as tackifier resins, 12 parts by mass of (D1) as a plasticizer, and (E1) as an antioxidant were melt-mixed at 180° C. to obtain a hot-melt adhesive. Thereafter, corona treatment was performed on a polypropylene film having a thickness of 43 μm, then a printing treatment having a primer effect was performed on the polypropylene film, and the hot-melt adhesive was applied on the polypropylene film so that the thickness of the adhesive layer was 24 μm, thereby fabricating an adhesive tape having a width of 20 mm.

### Examples 2 to 12 and Comparative Examples 1 and 2

Adhesive tapes according to Examples 2 to 12 and adhesive tapes according to Comparative Examples 1 and 2 were fabricated by the same method as in Example 1 based on the components and blending presented in Table 1.

### Evaluation Result

The evaluation results on the HM workability, odor, self-adhesion force, and self-adhesive creep resistance of the adhesive tapes according to Examples and Comparative Examples are presented in Table 1. The criteria for “○”, “Δ”, and “x” in the table are as follows.

### HM Workability

The adhesive was melted at 160° C. and applied to a base material such as OPP at a speed of 30 m/min or more.

At that time, the HM workability was evaluated in two grades of:

○: visually, adhesive can be applied to entire coating face of OPP film without being interrupted.

x: visually, portion where adhesive is interrupted is confirmed at part of coating face of OPP film.

### Odor

Fifteen subjects were asked to directly smell the sample for odor evaluation.

The odor was evaluated in two grades of:

1: it smells unpleasant

0: it does not smell or it smells but does not disturb,

and the average value thereof was determined. The judgment was made as follows based on the average value.

○: average value of questionnaire is less than 0.5 point and thus adhesive tape is usable without problem

x: average value of questionnaire is 0.5 point or more and thus adhesive tape is practically not usable

### Self-Adhesion Force

○: 12 N/20 mm or more

x: less than 12 N/20 mm

### Self-Adhesive Creep Resistance

○: less than 20 mm

Δ: 20 mm or more and less than 30 mm

x: 30 mm or more

### Tack Sensory Test

The degree of stickiness that fifteen subjects felt when they repeatedly held the adhesive tapes of Examples and Comparative Examples between their index fingers and thumbs and released the adhesive tapes was defined as tack feel, and the tack feel was evaluated in three grades of:

3: stronger

2: equivalent

1: weaker

as compared to that in Comparative Example 1 as a reference by the fifteen subjects and judged as follows from the average value thereof

○: sample with average value of questionnaire of 2.0 or more

Δ: sample with average value of questionnaire of 1.5 or more and less than 2.0

x: sample with average value of questionnaire of less than 1.5

The number of repetitions was arbitrary, but the standard was 4 to 5 times, and the contact time of the thumb with the adhesive face was set to be as short as possible, less than 1 second.

The initial adhesive property to the adherend is sufficient when the evaluation result in the tack sensory test is favorable, and this is preferable in terms of feel of use by the user. However, the initial adhesive property is insufficient when the evaluation result in the tack sensory test is poor, and this is not preferable.

TABLE 1

| | | Com- | | | | Com- | | | | | | | | | |
|---|---|---|---|---|---|---|---|---|---|---|---|---|---|---|---|
| | | parative | | | | parative | | Ex- | | Ex- | | Ex- | | Ex- | |
| | | Example 1 | | Example 1 | | Example 2 | | ample 2 | | ample 3 | | ample 4 | | ample 5 | |
| | | Parts | wt % | Parts | wt % | Parts | wt % | Parts | wt % | Parts | wt % | Parts | wt % | Parts | wt % |
| (A1) QUINTAC 3433N | SIS | 40 | 14.4 | 40 | 16.3 | 40 | 16.3 | 40 | 16.3 | 40 | 16.3 | 40 | 16.3 | 40 | 16.3 |
| (A2) QUINTAC 3190 | SIS | 60 | 21.6 | 60 | 24.5 | 60 | 24.5 | 60 | 24.5 | 60 | 24.5 | 60 | 24.5 | 60 | 24.5 |
| Sum of SISs | | 100 | 36.0 | 100 | 40.8 | 100 | 40.8 | 100 | 40.8 | 100 | 40.8 | 100 | 40.8 | 100 | 40.8 |
| (B1) YS RESIN | Terpene resin | 10 | 3.6 | 10 | 4.1 | 10 | 4.1 | 10 | 4.1 | 10 | 4.1 | 10 | 4.1 | 10 | 4.1 |
| PX1150N | | | | | | | | | | | | | | | |
| (B2) QUINTONE S195 | C5/C9 resin | 60 | 21.6 | 60 | 24.5 | 80 | 36.7 | 85 | 34.7 | 80 | 32.7 | 60 | 24.5 | 40 | 16.3 |
| (B3) Petcoal 130 | Aromatic resin | 50 | 18.0 | | | | | | | | | | | | |
| (B4) YS RESIN | Styrene resin | | | 30 | 12.2 | | | | | | | | | | |
| SX100 | | | | | | | | | | | | | | | |
| (B5) FTR6125 | Styrene/ | | | | | | | 5 | 2.0 | 10 | 4.1 | 30 | 12.2 | 50 | 20.4 |
| | aliphatic resin | | | | | | | | | | | | | | |
| Sum of resins | | 120 | 43.2 | 100 | 40.8 | 100 | 40.8 | 100 | 40.8 | 100 | 40.8 | 100 | 40.8 | 100 | 40.8 |
| (C1) SUPER #1500 | Calcium | 20 | 7.2 | 20 | 8.2 | 20 | 8.2 | 20 | 8.2 | 20 | 8.2 | 20 | 8.2 | 20 | 8.2 |
| | carbonate | | | | | | | | | | | | | | |
| (C2) NIPGEL BY600 | Silica | 10 | 3.6 | 10 | 4.1 | 10 | 4.1 | 10 | 4.1 | 10 | 4.1 | 10 | 4.1 | 10 | 4.1 |
| (C3) NIPGEL BY001 | Silica | 2 | 0.7 | 2 | 0.8 | 2 | 0.8 | 2 | 0.8 | 2 | 0.8 | 2 | 0.8 | 2 | 0.8 |
| Sum of fillers | | 32 | 11.5 | 32 | 13.1 | 32 | 13.1 | 32 | 13.1 | 32 | 13.1 | 32 | 13.1 | 32 | 13.1 |
| (D1) SNH100 | Naphthenic oil | 25 | 8.0 | 12 | 4 [symbol] 9 | 12 | 4 [symbol] 9 | 12 | 4.9 | 12 | 4.9 | 12 | 4.9 | 12 | 4.9 |
| (E1) ANTAGE | Antioxidant | 1 | 0.4 | 1 | 0.4 | 1 | 0.4 | 1 | 0.4 | 1 | 0.4 | 1 | 0.4 | 1 | 0.4 |
| AW-500 | | | | | | | | | | | | | | | |

| | | | | | | | | | | | | | | |
|---|---|---|---|---|---|---|---|---|---|---|---|---|---|---|
| Sum | 278 | 100 | 245 | 100 | 245 | 100 | 245 | 100 | 245 | 100 | 245 | 100 | 245 | 100 |

| | | | | | | | |
|---|---|---|---|---|---|---|---|
| Styrene resin/all resins (wt %) | 0.0 | 30.0 | 0.0 | 5.0 | 10.0 | 30.0 | 50.0 |
| Oil (wt %) | 9.0 | 4.8 | 4.8 | 4.9 | 4 [symbol] 9 | 4 [symbol] 9 | 4.9 |
| Styrene:oil | — | 1:0.40 | — | 1:2.40 | 1:1.20 | 1:0.40 | 1:0.24 |
| HM workability | ◯ | ◯ | ◯ | ◯ | ◯ | ◯ | ◯ |
| Odor | X | ◯ | ◯ | ◯ | ◯ | ◯ | ◯ |
| Tack sensory test | ◯ | ◯ | ◯ | ◯ | ◯ | ◯ | ◯ |
| Self-adhesion force | X | ◯ | ◯ | ◯ | ◯ | ◯ | ◯ |
| Self-adhesion force [N/20 mm] | 7.6 | 16.5 | 18.6 | 18.3 | 16.8 | 18.1 | 12.4 |
| Self-adhesive creep resistance | X | ◯ | X | Δ | ◯ | ◯ | ◯ |
| Self-adhesive creep resistance [mm] | 32.5 | 5.1 | 32.7 | 20.5 | 14.3 | 6.6 | 4.8 |

[symbol]

indicates data missing or illegible when filed

TABLE 2

| | | | | | | | | Example | | Example | | Ex- | | Ex- | |
|---|---|---|---|---|---|---|---|---|---|---|---|---|---|---|---|
| | | Example 6 | | Example 7 | | Example 8 | | 9 | | 10 | | ample 11 | | ample 12 | |
| | | Parts | wt % | Parts | wt % | Parts | wt % | Parts | wt % | Parts | wt % | Parts | wt % | Parts | wt % |
| (A1) QUINTAC | SIS | 40 | 16.3 | 40 | 15.7 | 40 | 16.5 | 40 | 16.3 | 40 | 16.1 | 40 | 15.8 | 40 | 15.5 |
| 3433N | | | | | | | | | | | | | | | |
| (A2) QUINTAC 3190 | SIS | 60 | 24.5 | 60 | 25.1 | 60 | 24.8 | 60 | 24.5 | 60 | 24.1 | 60 | 23.7 | 60 | 23.3 |
| Sum of SISs | | 100 | 40.8 | 100 | 41.8 | 100 | 41.3 | 100 | 40.8 | 100 | 40.2 | 100 | 39.5 | 100 | 38.8 |
| (B1) YS RESIN | Terpene resin | 10 | 4.1 | 10 | 4.2 | 10 | 4.1 | 10 | 4.1 | 10 | 4.0 | 10 | 4.0 | 10 | 3.9 |
| PX1150N | | | | | | | | | | | | | | | |
| (B2) QUINTONE | C5/C9 resin | 30 | 12.2 | 60 | 25.1 | 60 | 24.8 | 60 | 24.5 | 60 | 24.1 | 60 | 23.7 | 60 | 23.3 |
| S195 | | | | | | | | | | | | | | | |
| (B3) Petcoal 130 | Aromatic resin | | | | | | | | | | | | | | |
| (B4) YS RESIN | Styrene resin | | | | | | | | | | | | | | |
| SX100 | | | | | | | | | | | | | | | |
| (B5) FTR6125 | Styrene/ | 60 | 24.5 | 30 | 12.6 | 30 | 12.4 | 30 | 12.2 | 30 | 12.0 | 30 | 11.0 | 30 | 11.6 |
| | aliphatic resin | | | | | | | | | | | | | | |
| Sum of resins | | 100 | 40.8 | 100 | 41.8 | 100 | 41.3 | 100 | 40.8 | 100 | 40.2 | 100 | 39.5 | 100 | 38.8 |
| (C1) SUPER #1500 | Calcium | 20 | 8.2 | 20 | 8.4 | 20 | 8.3 | 20 | 8.2 | 20 | 6.0 | 20 | 7.9 | 20 | 7.8 |
| | carbonate | | | | | | | | | | | | | | |
| (C2) NIPGEL BY600 | Silica | 10 | 4.1 | 10 | 4.2 | 10 | 4.1 | 10 | 4.1 | 10 | 4.0 | 10 | 4.0 | 10 | 3.9 |
| (C3) NIPGEL BY001 | Silica | 2 | 0.8 | 2 | 0.8 | 2 | 0.8 | 2 | 0.8 | 2 | 0.8 | 2 | 0.8 | 2 | 0.8 |
| Sum of fillers | | 32 | 13.1 | 32 | 13.4 | 32 | 13.2 | 32 | 13.1 | 32 | 12.9 | 32 | 12.6 | 32 | 12.4 |
| (D1) SNH100 | Naphthenic oil | 12 | 4.9 | 6 | 2.5 | 8 | 3.7 | 12 | 4.8 | 16 | 6.4 | 20 | 7.9 | 25 | [symbol] .7 |
| (E1) ANTAGE | Antioxidant | 1 | 0.4 | 1 | 0.4 | 1 | 0.4 | 1 | 0.4 | 1 | 0.4 | 1 | 0.4 | 1 | 0.4 |
| AW-500 | | | | | | | | | | | | | | | |

| | | | | | | | | | | | | | | |
|---|---|---|---|---|---|---|---|---|---|---|---|---|---|---|
| Sum | 245 | 100 | 239 | 100 | 242 | 100 | 245 | 100 | 249 | 100 | 250 | 100 | 250 | 100 |

| | | | | | | | |
|---|---|---|---|---|---|---|---|
| Styrene resin/all resins (wt %) | 60.0 | 30.0 | 30.0 | 30.0 | 30.0 | 30.0 | 30.0 |
| Oil (wt %) | 4.9 | 2.5 | 3.7 | 4.9 | 6.4 | 7.9 | 9.7 |
| Styrene:oil | 1:0.20 | 1:0.20 | 1:0.30 | 1:0.40 | 1:0.53 | 1:0.67 | 1:0.83 |
| HM workability | ◯ | ◯ | ◯ | ◯ | ◯ | ◯ | ◯ |
| Odor | ◯ | ◯ | ◯ | ◯ | ◯ | ◯ | ◯ |
| Tack sensory test | Δ | ◯ | ◯ | ◯ | ◯ | ◯ | ◯ |
| Self-adhesion force | ◯ | ◯ | ◯ | ◯ | ◯ | ◯ | ◯ |
| Self-adhesion force [N/20 mm] | 12.4 | 18.2 | 17.3 | 18.1 | 17.0 | 16.4 | 15.7 |
| Self-adhesive creep resistance | ◯ | ◯ | ◯ | ◯ | ◯ | ◯ | Δ |
| Self-adhesive creep resistance [mm] | 4.8 | 3.1 | 8.4 | 6.6 | [symbol] .8 | 15.8 | 24.8 |

[symbol]

indicates data missing or illegible when filed

What is claimed is:

1. A hot-melt adhesive composition comprising at least an elastomer, a tackifier resin, a filler, and a petroleum-based plasticizer, wherein
the elastomer is a styrene-isoprene-styrene block copolymer (SIS) having a styrene content of 16% by mass or more and 40% by mass or less, and
a terpene resin, a C5/C9 petroleum resin, and a homopolymer of a styrene-based monomer and/or a copolymer of a styrene-based monomer/an aliphatic monomer are contained as the tackifier resin.

2. The hot-melt adhesive composition according to claim 1, wherein an amount of the homopolymer of a styrene-based monomer and/or the copolymer of a styrene-based monomer/an aliphatic monomer blended is 2.5% by mass or more and 55% by mass or less based on a total mass of all the tackifier resins.

3. The hot-melt adhesive composition according to claim 1, wherein an amount of the petroleum-based plasticizer blended is 2.5% by mass or more and 9.0% by mass or less based on a total mass of the hot-melt adhesive composition.

4. The hot-melt adhesive composition according to claim 2, wherein an amount of the petroleum-based plasticizer blended is 2.5% by mass or more and 9.0% by mass or less based on a total mass of the hot-melt adhesive composition.

5. The hot-melt adhesive composition according to claim 1, wherein a blended amount ratio of the homopolymer of a styrene-based monomer and/or the copolymer of a styrene-based monomer/an aliphatic monomer to the petroleum-based plasticizer (the amount of the homopolymer of a styrene-based monomer and/or the copolymer of a styrene-based monomer/an aliphatic monomer blended:the amount of the petroleum-based plasticizer blended) is 1:0.20 to 1.20.

6. The hot-melt adhesive composition according to claim 2, wherein a blended amount ratio of the homopolymer of a styrene-based monomer and/or the copolymer of a styrene-based monomer/an aliphatic monomer to the petroleum-based plasticizer (the amount of the homopolymer of a styrene-based monomer and/or the copolymer of a styrene-based monomer/an aliphatic monomer blended:the amount of the petroleum-based plasticizer blended) is 1:0.20 to 1.20.

7. The hot-melt adhesive composition according to claim 3, wherein a blended amount ratio of the homopolymer of a styrene-based monomer and/or the copolymer of a styrene-based monomer/an aliphatic monomer to the petroleum-based plasticizer (the amount of the homopolymer of a styrene-based monomer and/or the copolymer of a styrene-based monomer/an aliphatic monomer blended:the amount of the petroleum-based plasticizer blended) is 1:0.20 to 1.20.

8. The hot-melt adhesive composition according to claim 4, wherein a blended amount ratio of the homopolymer of a styrene-based monomer and/or the copolymer of a styrene-based monomer/an aliphatic monomer to the petroleum-based plasticizer (the amount of the homopolymer of a styrene-based monomer and/or the copolymer of a styrene-based monomer/an aliphatic monomer blended:the amount of the petroleum-based plasticizer blended) is 1:0.20 to 1.20.

9. The hot-melt adhesive composition according to claim 1, wherein the homopolymer of a styrene-based monomer and/or the copolymer of a styrene-based monomer/an aliphatic monomer is a styrene-based monomer/aliphatic monomer copolymer.

10. The hot-melt adhesive composition according to claim 2, wherein the homopolymer of a styrene-based monomer and/or the copolymer of a styrene-based monomer/an aliphatic monomer is a styrene-based monomer/aliphatic monomer copolymer.

11. The hot-melt adhesive composition according to claim 3, wherein the homopolymer of a styrene-based monomer and/or the copolymer of a styrene-based monomer/an aliphatic monomer is a styrene-based monomer/aliphatic monomer copolymer.

12. The hot-melt adhesive composition according to claim 4, wherein the homopolymer of a styrene-based monomer and/or the copolymer of a styrene-based monomer/an aliphatic monomer is a styrene-based monomer/aliphatic monomer copolymer.

13. The hot-melt adhesive composition according to claim 5, wherein the homopolymer of a styrene-based monomer and/or the copolymer of a styrene-based monomer/an aliphatic monomer is a styrene-based monomer/aliphatic monomer copolymer.

14. The hot-melt adhesive composition according to claim 6, wherein the homopolymer of a styrene-based monomer and/or the copolymer of a styrene-based monomer/an aliphatic monomer is a styrene-based monomer/aliphatic monomer copolymer.

15. The hot-melt adhesive composition according to claim 7, wherein the homopolymer of a styrene-based monomer and/or the copolymer of a styrene-based monomer/an aliphatic monomer is a styrene-based monomer/aliphatic monomer copolymer.

16. The hot-melt adhesive composition according to claim 8, wherein the homopolymer of a styrene-based monomer and/or the copolymer of a styrene-based monomer/an aliphatic monomer is a styrene-based monomer/aliphatic monomer copolymer.

17. The hot-melt adhesive composition according to claim 1, wherein the petroleum-based plasticizer is a naphthenic process oil.

18. An adhesive tape comprising an adhesive layer obtained from the hot-melt adhesive composition according to claim 1.

19. The adhesive tape according to claim 18, which is used for binding a vegetable.
